(19) United States
(12) Patent Application Publication
(10) Pub. No.: US 2026/0077365 A1
(43) Pub. Date: Mar. 19, 2026

(54) SHOWERHEAD ATTACHMENT

(71) Applicant: SHOWER TWO TRUST, Houston, TX (US)

(72) Inventor: Jacob Rutherford Griswold, Houston, TX (US)

(73) Assignee: SHOWER TWO TRUST, Houston, TX (US)

(21) Appl. No.: 18/887,306

(22) Filed: Sep. 17, 2024

(51) Int. Cl. B05B 1/18; B05B 15/65

(52) U.S. Cl. CPC B05B 1/185; B05B 15/65

(57) ABSTRACT

A system may include a telescoping supply line adjustable in length between a first end of the supply line and a second end of the supply line. The system may include a first shower head coupled proximate the first end of the supply line. The system may include a second shower head coupled to the supply line at a second end opposite the first shower head. The adjustability in length of the supply line may adjust a distance between the first shower head and the second shower head. The system may include a support coupled to the supply line to support the supply line. The system may include an inlet coupler between the supply line and the first shower head to form a fluid flow path into the supply line. The fluid flow path may outlet through the first shower head and the second shower head.

### BACKGROUND

Showering is a necessary process for personal hygiene. It is a process by which the body is cleaned by running water over it to remove soilage and soap.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a perspective view of a system, according to one or more examples of the disclosure.

FIG. 2 is a perspective view of another embodiment of the system of FIG. 1, according to one or more examples of the disclosure.

FIG. 3 is a partially dissambled view of the system of FIG. 1, according to one or more examples of the disclosure.

FIG. 4 is a perspective view of another embodiment of the system of FIG. 1, according to one or more examples of the disclosure.

FIG. 5 is a perspective view of free-standing system, according to one or more examples of the disclosure.

FIG. 6 is a flowchart depicting a method, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers'specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

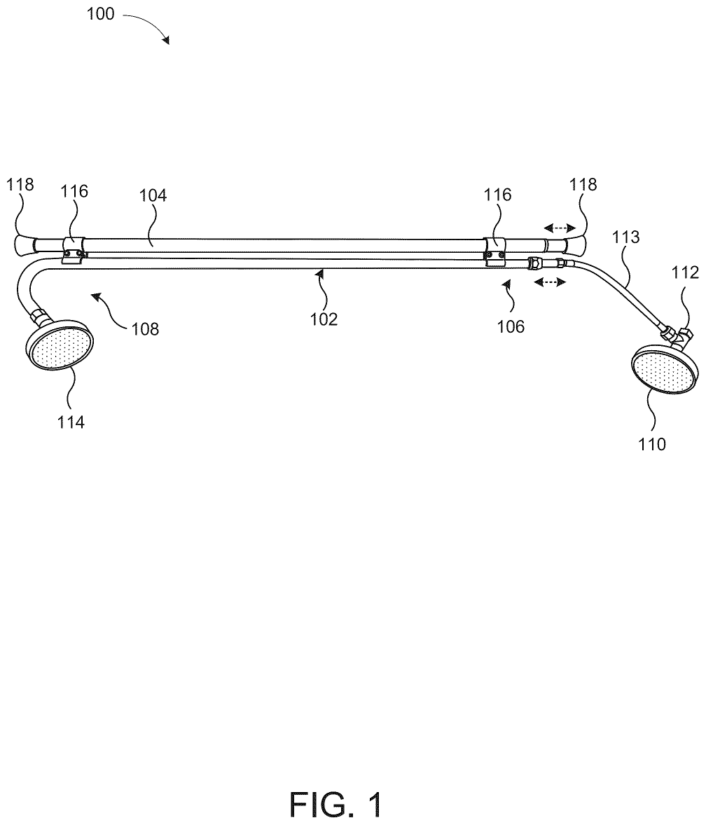

FIG. 1 is a perspective view of a system 100, according to one or more examples of the disclosure. Some examples of the system 100 may provide a dual shower option for increasing water flow or allowing for multiple users of the system 100 to do so simultaneously without being restricted to the use of a single standard shower head.

In some examples, the system 100 includes a supply line 102 and a support 104. The supply line 102 may be a tubular structure. The supply line 102 may include a first end 106 and a second end 108. The supply line 102 may extend between the first end 106 and the second end 108 to transport a fluid along a length of an interior of the supply line 102. The supply line 102 may be metal, plastic, composite, or other natural or synthetic materials, or combination of natural and/or synthetic materials.

The supply line 102 may form a pipe, conduit, or other enclosed structure capable of transporting a fluid. The supply line 102 may have a circular or non-circular cross-section. The supply line 102 may have a consistent cross-sectional geometry along a length of the supply line 102 or the cross-sectional geometry may be different at one point of the supply line 102 relative to another point of the supply line 102.

In some embodiments, the supply line 102 includes a linear portion. The supply line 102 may include a non-linear portion. In the illustrated example, the supply line 102 is linear proximate the first end 106 and non-linear proximate the second end 108 of the supply line 102. Other embodiments of the supply line 102 may include fewer or more linear and/or non-linear portions. The supply line 102 may be rigid or flexible or may include a rigid portion and/or a flexible portion.

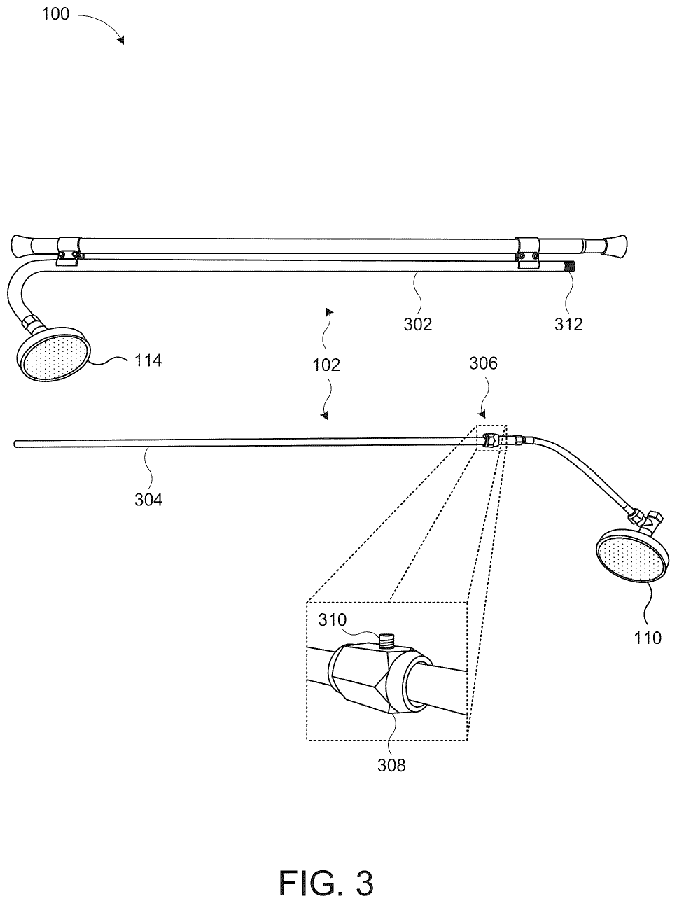

In some embodiments, the supply line 102 may be adjustable in length to increase or decrease a distance between the first end 106 and the second end 108. For example, the supply line 102 may be telescopically adjustable to change an overall length of the supply line 102. Some examples of a telescoping structure of the supply line 102 are shown and described in more detail with respect to FIG. 3 and the accompanying description below.

In some embodiments, the supply line 102 is in fluid communication with a first shower head 110. The first shower head 110 may be coupled to the supply line 102 at the first end 106 of the supply line 102. The first shower head 110 may be coupled to the first end 106 of the supply line 102 via an inlet coupler 112 such that the inlet coupler 112 is interstitial to the first end 106 of the supply line 102 and the first shower head 110. In some embodiments, the inlet coupler 112 may be a three-port coupler to allow a fluid, such as water, from a fluid source to enter the system 100 and pass to the first shower head 110 and into the supply line 102. The inlet coupler 112 may include threads or another connection structure on at least one connection point (e.g., fluid inlet, shower head outlet, supply line outlet). In some embodiments, the inlet coupler 112 may be interstitial to the second shower head 114 and the supply line 102. In some embodiments, the diameter of at least one of the supply line 102 and/or the inlet coupler 112 may be different from another diameter of the system 100. For example, some embodiments may include diameter optimization to improve fluid pressure through the system 100.

In some embodiments, the inlet coupler 112 may utilize another fitting type (e.g., sharktooth, friction fit, crimp, clamp, etc.) on at least one other connection point. Different connection types or combinations of connection types may be used. In some embodiments, the inlet coupler 112 is a “straight-90” in which an interior path is straight with a junction positioned at ninety degrees from the straight path. Other shapes and geometries may be implemented. For example, the inlet coupler 112 may have a “y-shaped” geometry, a straight-45, etc.

The first shower head 110 may be coupled directly to the inlet coupler 112. In some embodiments, the first shower head 110 may include or be a wand or hand-held sprayer which may be coupled to the inlet coupler 112 via a flexible line (not shown). The first shower head 110 may be adjustable to pivot at or at about the connection with the inlet coupler 112. Alternatively, the first shower head 110 may be fixed. In some embodiments, the first shower head 110 is coupled to the supply line 102 via an intermediate line 113. The intermediate line 113 may be flexible or rigid.

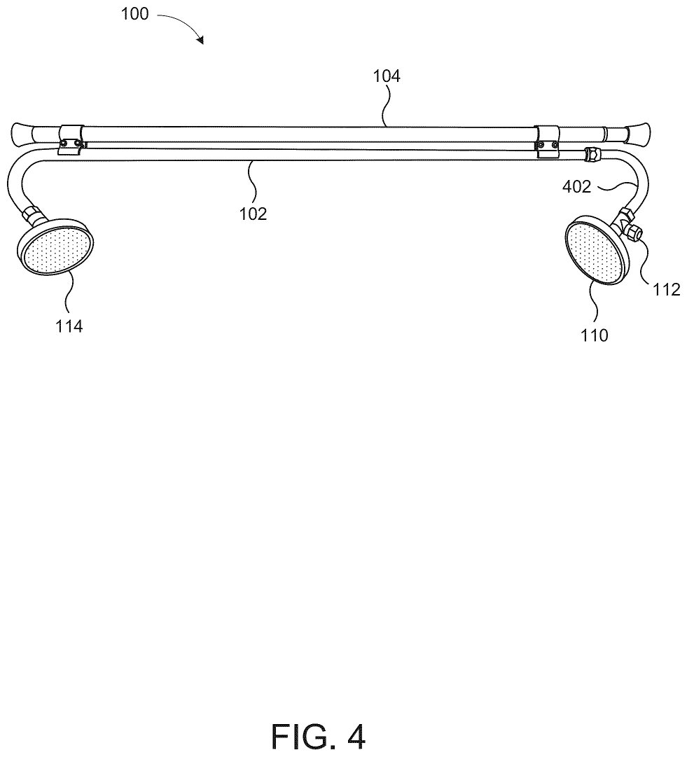

In some embodiments, the intermediate line 113 couples between the inlet coupler 112 and the supply line 102 to provide flexibility in the mounting position of the first shower head 110. In other embodiments, the intermediate line 113 may be rigid to maintain a relative position of the first shower head 110 and the supply line 102. An example of a rigid alternative to the inclusion of the intermediate line 113 is shown and described with respect to FIG. 4 below.

The system 100 may include a second shower head 114. The second shower head 114 may be coupled to the second end 108 of the supply line 102. The second shower head 114 may be similar to or different from the first shower head 110. For example, the second shower head 114 may include a wand or handheld sprayer or may be a traditional shower head, as illustrated in FIG. 1, and may include a rigid or flexible connection with the supply line 102. For a second example, the second shower head 114 may be of a different design (e.g., variable spray pattern) than is the first shower head 110.

The second shower head 114 may be positioned to angle at least partially towards the first shower head 110. The angle of the second shower head 114 may be based on at least one of a geometry of the second end 108 of the supply line 102 and/or a pivot joint of the second shower head 114. In some embodiments, the second shower head 114 may be positioned to be approximately level with the first shower head 110. In other embodiments, the second shower head 114 may be offset in height from the first shower head 110. In some embodiments, one or both of the first shower head 110 and the second shower head 114 may be adjustable to affect a flow rate. For example, the second shower head 114 may be adjustable to increase, slow, or stop a selectable flow rate of fluid through the second shower head 114. This may allow for flow control at one or both of the first shower head 110 and the second shower head 114 based, at least in part, on the application and/or desired performance of the system 100.

In some embodiments, the support 104 is coupled to or mechanically engaged with the supply line 102. The support 104 may provide structural support to the supply line 102. In some embodiments, the support 104 is positioned to be parallel to the supply line 102. The support 104 may have a circular cross-sectional geometry or a non-circular cross-sectional geometry. In some embodiments, the support 104 is primarily linear in geometry. In other embodiments, the support 104 may have a primarily curved or otherwise non-linear geometry.

The support 104 may have an adjustable length. For example, the support 104 may be adjustable by twisting an internal portion relative to an external portion to extend or retract a length of the support 104. In some embodiments, the support 104 may have a length which is adjustable and/or securable via a friction fitment, snap button, set screw, spring loader, a plurality of detents, or the like.

The support 104 may be coupled to the supply line 102 via one or more connectors 116. The one or more connectors 116 may be clamped to one or both of the support 104 and the supply line 102. In the illustrated embodiment, the one or more connectors 116 clamp onto the supply line 102 and onto the support 104 and are secured with one or more screws. In other embodiments, one or more of the one or more connectors 116 may take another form (e.g., clamp, tie, loop, strap, lashing, sleeve, bolt, screw, weld, adhesive, chain, webbing, cord, etc.) which may rigidly or flexibly couple the supply line 102 and the support 104. The one or more connectors 116 may resist or facilitate movement of the supply line 102 relative to the support 104 or vice versa. In some embodiments, the one or more connectors 116 may be permanently or removably coupled to one or both of the supply line 102 and the support 104.

The support 104 may include end caps 118. The end caps 118 may be positioned at either end of the support 104. The end caps 118 may be configured to provide mounting force between the support 104 and a mounting location, such as a wall or other structure to facilitate holding of the system 100 in place during use. In some embodiments, the mounting force is a friction force (e.g., rubber pad, textured interface, etc.). In other embodiments, the mounting force results from a penetration and tension/compression engagement (e.g., screw, spike, bolt, anchor, etc.).

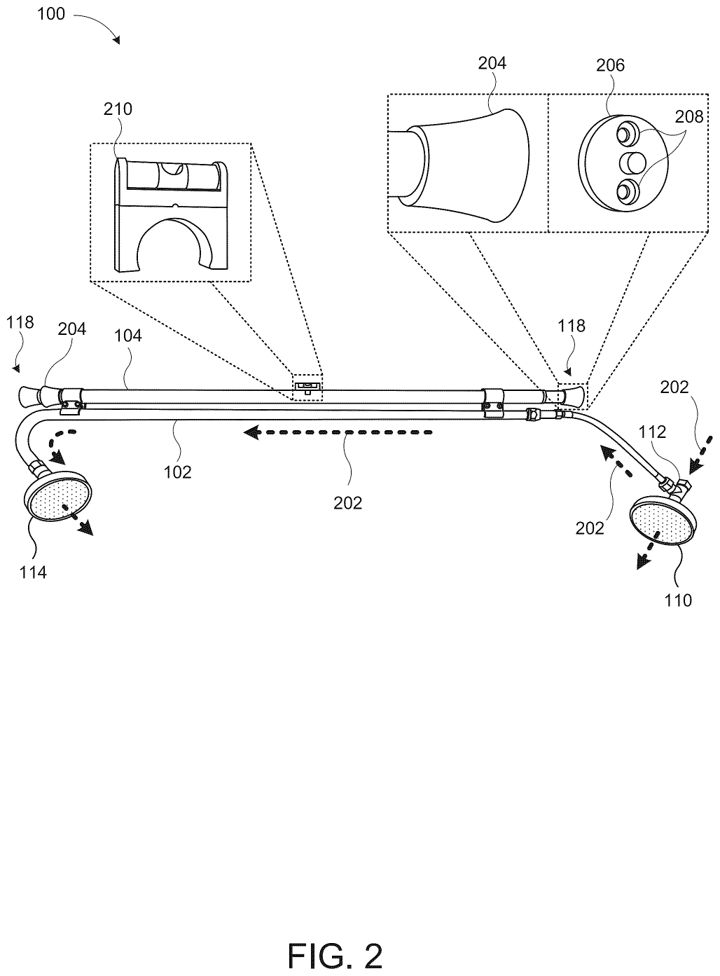

FIG. 2 is a perspective view of another embodiment of the system 100 of FIG. 1, according to one or more examples of the disclosure. In the illustrated embodiment, a fluid flow path 202 is shown. The fluid flow path 202 may enter the system 100 at the inlet coupler 112. In the illustrated embodiments, the fluid flow path 202 moves from the inlet coupler 112 to both the first shower head 110 and into the supply line 102. From the supply line 102, the fluid flow path 202 moves to the second shower head 114.

The system 100 of FIG. 2 illustrates an embodiment the end caps 118 positioned on the support 104. In some embodiments, the end caps 118 include an end cap cover 204. The end cap cover 204 may be sized to at least partially cover the end cap 118. The end cap cover 204 may be shaped to slide along the support 104 and at least partially over the end cap 118. In some embodiments, the end cap cover 204 may at least partially cover the end cap 118 to provide at least one of an aesthetic masking and/or protective masking of the end cap 118. For example, the end cap cover 204 may be made of a material similar or different in makeup and/or appearance to the support 104 or to the mounting surface against which the end cap 118 may be positioned. The end cap cover 204 may provide a fluid seal to reduce contact of the end cap 118 with water or other fluids, a dust cover, an ultraviolet light shield, and/or the like. In some embodiments, the end cap cover 204 may be secured to the end cap 118 by a friction fit, a mechanical fastener, a magnet, a clip, an adhesive, or the like.

In some embodiments, the end cap 118 may include a mounting plate 206. The mounting plate 206 may be coupleable to the end cap 118 or may be integrated into the end cap 118. The mounting plate 206 may couple to the end cap 118 via a fastener, adhesive, or other mechanism. In some embodiments, the mounting plate 206 may friction fit with the end cap 118. For example, the mounting plate 206 may be installed on a wall or other mounting surface with the end cap 118 engaging with the installed mounting plate 206 to support the end cap 118 and the support 104.

For example, the mounting plate 206 may include one or more apertures 208 to facilitate mounting hardware such as fasteners like screws, nails, pins, or the like. In some embodiments, the mounting plate 206 may include spikes, points, knurling, or other texture or structures on one or more surfaces of the mounting plate 206 to engage with a mounting surface to which the support 104 is to be secured. For example, the mounting plate 206 may facilitate a more permanent installation on drywall, tile, stone, synthetic material, wood, or the like.

The system 100 may also include a leveling device 210. The leveling device 210 may be a bubble level, or another type of mechanical or electronic level, to provide an indication of an orientation of the system 100. The leveling device 210 may be removable and/or repositionable along the support 104 or other component of the system 100. In some embodiments, the leveling device 210 may be integrated with the system 100.

FIG. 3 is a partially disassembled view of the system 100 of FIG. 1, according to one or more examples of the disclosure. In the illustrated embodiment, the supply line 102 is separated out into an outer housing 302 and an inner housing 304. The outer housing 302 may have a cross-sectional geometry larger than a cross-sectional geometry of the inner housing 304 to allow for insertion of the inner housing 304 into the outer housing 302. In some embodiments, one or both of the inner housing 304 and the outer housing 302 may include a gasket, seal, guide, or other structure or mechanism to facilitate relative translation of the inner housing 304 and the outer housing 302 and/or provide sealing or other functions within the supply line 102.

The inner housing 304 may include an extension control mechanism 306. The extension control mechanism 306 may be coupled to the inner housing 304 and may be sized to extend over the outer housing 302 to interface with a coupling interface 312 of the outer housing 302. The extension control mechanism 306 may be sized and positioned on the inner housing 304. With the inner housing 304 inserted into the outer housing 302, the extension control mechanism 306 engages with the outer housing 302. In some embodiments, the coupling interface 312 of the outer housing 302 may include a threaded portion, a ridged portion, a friction land, and/or the like. The extension control mechanism 306 may take the form of a threaded cap configured to retain and seal relative to the inner housing 304 and couple to and control the position of the outer housing 302 relative to the inner house 304.

The extension control mechanism 306 may secure the inner housing 304 within the outer housing 302. The extension control mechanism 306 may provide a fluid-tight seal between the outer housing 302 and the inner housing 304. In some embodiments, the extension control mechanism 306 includes a body structure 308 such as a fitting like a nut, pneumatic coupling, or other complementary structure to the coupling interface 312.

In some embodiments, the extension control mechanism 306 includes a locking structure 310. The locking structure 310 may be a set screw, detent, or other structure to provide a force resistive to operation of the extension control mechanism 306 to reduce slippage of the inner housing 304 within the outer housing 302, reduce leaks at the extension control mechanism 306, reduce unintended loosening of the extension control mechanism 306, and/or the like. In the illustrated embodiment and others, the locking structure 310 includes a set screw. Other embodiments may use a cotter pin, lock washer, retention ring, nylon or other locking sleeve, and/or the like.

FIG. 4 is a perspective view of another embodiment of the system 100 of FIG. 1, according to one or more examples of the disclosure. In the illustrated embodiment and others, the supply line 102 includes a rigid end 402 proximate the first shower head 110 and to which the first shower head 110 is connected via the inlet coupler 112. The rigid end 402 may provide a more stable positioning for the first shower head 110 over a flexible connection with the trade-off of lower adjustability of the first shower head 110 relative to the supply line 102. In some embodiments, the rigid end 402 may have a curved geometry to position the first shower head 110 similar and/or complementary to a position of the second shower head 114. For example, one or both of the first shower head 110 and/or the second shower head 114 may be angled to direct fluid away from the supply line 102.

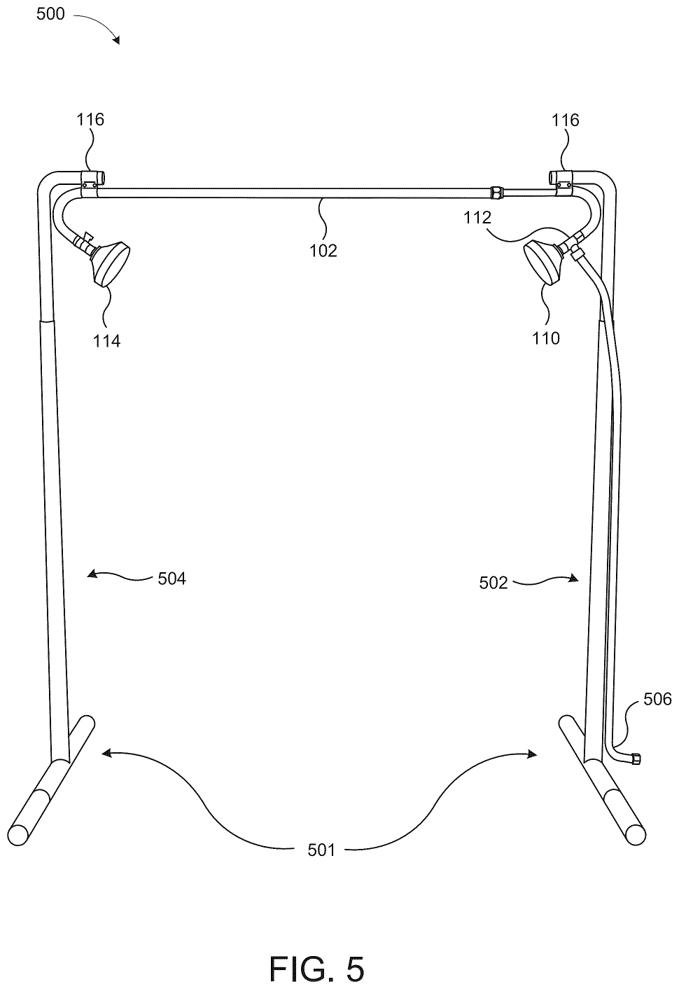

FIG. 5 is a perspective view of a free-standing system 500, according to one or more examples of the disclosure. In the illustrated embodiment and others, the supply line 102 with the first shower head 110 and the second shower head 114 are supported by a free standing support frame 501 including a first free-standing support 502 and a second free-standing support 504. The first free-standing support 502 and the second free-standing support 504 may be configured to contact the ground/floor surface and extend away from the ground surface to support the supply line 102.

One or both of the first free-standing support 502 and the second free-standing support 504 may be adjustable in height and/or width. For example, one or both of the first free-standing support 502 and the second free-standing support 504 may be adjustable to change a height of the supply line 102 and the corresponding shower heads 110 and 114. In some embodiments, the first free-standing support 502 and the second free-standing support 504 may be coupled to the supply line via one or more connectors 116. In the illustrated embodiment and others, the first free-standing support 502 and the second free-standing support 504 are separate. In other embodiments, the first free-standing support 502 and the second free-standing support 504 may form a unified whole.

In the illustrated embodiment and others, the free-standing system 500 may be connected to a fluid access 506 via the inlet coupler 112. The fluid access 506 may be coupled to the inlet coupler 112 via a threaded interface, quick-connect, or other removable or permanent joining.

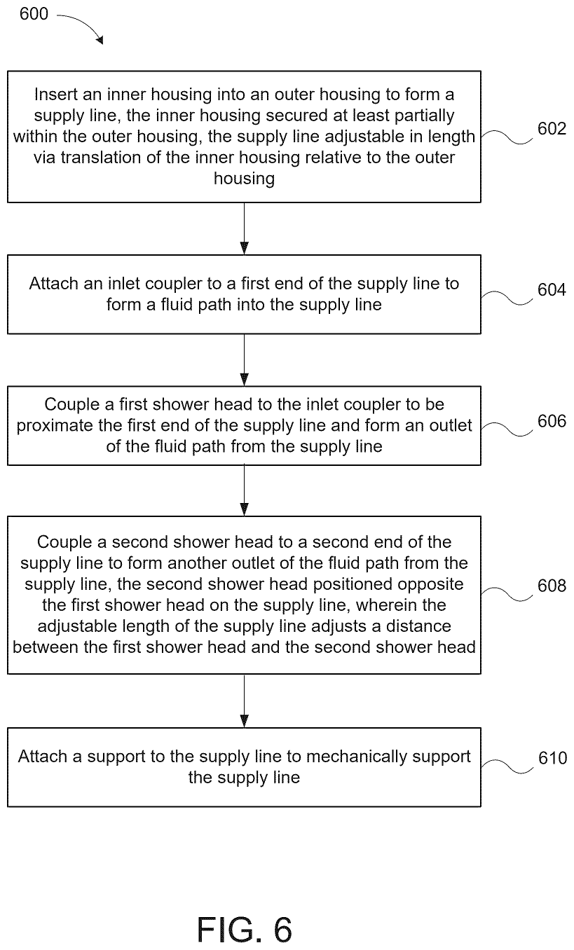

FIG. 6 is a flowchart depicting a method 600, according to one or more examples of the disclosure. In some embodiments, the method 600 includes, at block 602, inserting an inner housing into an outer housing to form a supply line, the inner housing secured at least partially within the outer housing, the supply line adjustable in length via translation of the inner housing relative to the outer housing. As described with respect to FIG. 3, the supply line 102 may include an inner housing 304 insertable into an outer housing 302. Translation of the inner housing 304 relative to the outer housing 302 may extend or reduce the length of the supply line 102 and the distance between the first shower head 110 and the second shower head 114.

The method 600 may include, at block 604, attaching an inlet coupler 112 to a first end 106 of the supply line 102 to form a fluid flow path 202 into the supply line 102. As shown and described with respect to FIG. 1, the inlet coupler 112 may be coupled to the first end 106 of the supply line 102. Some embodiments of the fluid flow path 202 are shown and described, with respect to FIG. 2, as moving into a through the supply line 102.

The method 600 may include, at block 606, coupling a first shower head 110 to the inlet coupler 112 to be proximate the first end 106 of the supply line 102 and form an outlet of the fluid flow path 202 from the supply line 102. The first shower head 110 may be adjustable across a range of output angles. The first shower head 110 may be adjustable to affect a spray pattern and/or flow rate of fluid through the first shower head 110.

The method 600 may include, at block 608, coupling a second shower head 114 to a second end 108 of the supply line 102 to form another outlet of the fluid flow path 202 from the supply line 102, the second shower head 114 positioned opposite the first shower head 110 on the supply line 102, wherein the adjustable length of the supply line 102 adjusts a distance between the first shower head 110 and the second shower head 114. As shown in FIG. 1, the first shower head 110 and the second shower head 114 may be positioned relative to one another based on the length of the supply line 102. In some embodiments, the relative positioning may be further adjustable based on an angle and orientation of the intermediate line 113.

The method 600 may include, at block 610, attaching a support 104 to the supply line 102 to mechanically support the supply line 102. As shown in and described relative to FIG. 1, the support 104 may be positioned to be parallel or non-parallel to the supply line 102 and coupled to the supply line 102 (e.g., via one or more connectors 116) to support the supply line 102. The support 104 may be positioned between two mounting surfaces, such as walls or the like, to suspend or otherwise support the supply line 102.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A system for personal showering, the system comprising:
a telescoping supply line adjustable in length between a first end of the supply line and a second end of the supply line;
a first shower head coupled to the supply line proximate the first end of the supply line and angled to direct fluid output by the first shower head away from the supply line;
a second shower head coupled to the supply line at a second end of the supply line opposite the first shower head and angled to direct fluid leaving the second shower head away from the supply line, wherein the adjustability in length of the supply line adjusts a distance between the first shower head and the second shower head;
a support coupled to the supply line to mechanically support the supply line, the support being adjustable in length; and
an inlet coupler coupled between the supply line and the first shower head to provide a fluid inlet to and form a fluid flow path into the supply line, the fluid flow path having outlet through the first shower head and the second shower head.

2. The system of claim 1, wherein the support is coupled to the supply line with one or more connectors.

3. The system of claim 1, further comprising an end cap positioned on an end of the support to secure the support in a mounting location.

4. The system of claim 1, wherein the telescoping structure of the supply line comprises an inner housing sized to fit within an outer housing.

5. The system of claim 4, wherein the supply line comprises an extension control mechanism to secure the inner housing relative to the outer housing.

6. The system of claim 5, wherein the extension control mechanism comprises a locking structure to reduce a movement of the extension control mechanism.

7. The system of claim 1, wherein the support is a free-standing support shaped to contact a ground surface and extend away from the ground to support the supply line.

8. A method comprising:
inserting an inner housing into an outer housing to form a telescoping supply line, the inner housing secured at least partially within the outer housing and the structural engagement therebetween fluidly sealed, the supply line adjustable in length via translation of the inner housing relative to the outer housing;
attaching an inlet coupler to a first end of the supply line to form a fluid flow path into the supply line;
coupling a first shower head to the inlet coupler to be proximate the first end of the supply line and form an outlet of the fluid flow path from the supply line;
coupling a second shower head to a second end of the supply line to form another outlet of the fluid flow path from the supply line, the second shower head positioned opposite the first shower head on the supply line, wherein the adjustable length of the supply line adjusts a distance between the first shower head and the second shower head; and
attaching a support to the supply line to mechanically support the supply line.

9. The method of claim 8, wherein attaching the support to the supply line comprises attaching one or more connectors between the support and the supply line.

10. The method of claim 8, further comprising coupling an end cap on an end of the support to secure the support in a mounting location.

11. The method of claim 8, wherein forming the supply line further comprising fastening an extension control mechanism to secure the inner housing relative to the outer housing.

12. The method of claim 11, wherein fastening the extension control mechanism includes installing a locking structure to reduce a movement of the extension control mechanism.

13. The method of claim 8, wherein attaching the support to the supply line comprises attaching a free-standing support shaped to contact a ground surface and support the supply line relative to the ground surface.

14. A system comprising:
a supply line telescopically adjustable in length;
a first shower head coupled to the supply line at a first end of the supply line;
a second shower head coupled to the supply line at a second end of the supply line opposite the first shower head, wherein the adjustable length of the supply line adjusts a distance between the first shower head and the second shower head;
a support coupled to the supply line to mechanically support the supply line; and
an inlet coupler interstitial between the supply line and the first shower head to form a fluid flow path into the supply line, the fluid flow path having outlet through the first shower head and through the second shower head.

15. The system of claim 14, wherein the support is coupled to the supply line with one or more connectors.

16. The system of claim 14, further comprising an end cap positioned on an end of the support to secure the support on a mounting surface.

17. The system of claim 14, wherein the supply line comprises an inner housing sized to fit within an outer housing to telescopically adjust the length of the supply line.

18. The system of claim 17, wherein the supply line comprises an extension control mechanism to secure the inner housing relative to the outer housing.

19. The system of claim 18, wherein the extension control mechanism comprises a locking structure to reduce a movement of the extension control mechanism.

20. The system of claim 14, wherein the support is a free-standing support shaped to contact a ground surface and extend away from the ground to support the supply line.
